(19) United States
(12) Patent Application Publication
(10) Pub. No.: US 2025/0128440 A1
(43) Pub. Date: Apr. 24, 2025

(54) RAZOR CARTRIDGE COMPRISING LUBRICATING RESERVOIRS

(71) Applicant: BIC Violex Single Member S.A., Anoixi (GR)

(72) Inventor: Ion - Ioannis ANTONAKIS, Anoixi (GR)

(73) Assignee: BIC Violex Single Member S.A., Anoixi (GR)

(21) Appl. No.: 18/834,503

(22) PCT Filed: Feb. 13, 2023
(86) PCT No.: PCT/EP2023/053496

§ 371 Date: Jul. 30, 2024

(30) Foreign Application Priority Data
Feb. 18, 2022 (EP) 22157490.8

(51) Int. Cl. B26B 21/40; B26B 21/44

(52) U.S. Cl. CPC B26B 21/4012; B26B 21/446

(57) ABSTRACT

A razor cartridge having one or more pore(s). The one or more pore(s) are configured to switch between a closed conformation and an opened conformation based on an external stimulus. A process for manufacturing the razor cartridge and a shaving razor assembly including the razor cartridge.

### CROSS REFERENCE TO RELATED APPLICATION

This is a National Stage Application under 35 U.S.C. § 371 of International Application No. PCT/EP2023/053496, filed Feb. 13, 2023, now published as WO 2023/156338 A1, which claims priority to European Patent Application No. 22157490.8, filed on Feb. 18, 2022, the entireties of which are incorporated herein by reference.

### TECHNICAL FIELD

The present disclosure relates to the field of razor cartridges. More specifically, the present disclosure relates to razor cartridges comprising lubricating reservoirs.

### BACKGROUND

Razors generally include a handle and a razor cartridge fixedly or releasably attached to the handle. The razor cartridge includes at least one blade for shaving hair. The razor cartridge may also include a lubricating strip, often extending parallel to at least one blade. The user holds the handle and repeatedly moves the razor across an area of the body to be shaved, e.g., the face, until hair is removed from the surface of the body. The lubrication strip may function to aid in shaving and to decrease or prevent skin irritation due to the repeated exposure of the skin to sharp razor blades.

In conventional razor cartridges the lubricating strip is often made of a porous structure comprising a lubricating composition therein. The lubricating composition, such as a gel, may mix with water during the shaving action to form a lubricating layer. However, often only the outer layer of the lubricating strip provides lubrication, as the lubricating composition found in deeper layers does not come into contact with water. Thus, the lubricating strip may not provide lasting lubrication. Further, after the outer layer has worn-out, the porous structure may lead to increased friction with the skin.

Further, during manufacturing of the razor cartridge, the lubricating strip may undergo elevated temperatures. The elevated temperatures during manufacturing may limit the range of ingredients usable for the lubricating composition.

The present disclosure aims to address one or more of the aforementioned problems of the lubricating strip.

### SUMMARY

In a first aspect, the present disclosure relates to a razor cartridge comprising a lubricant reservoir having one or more pore(s), wherein the one or more pore(s) are configured to switch between a closed conformation and an opened conformation based on an external stimulus.

In some embodiments, the lubricant reservoir may contain a lubricant.

In some embodiments, the external stimulus may be a change in temperature and/or pressure.

In some embodiments, the one or more pore(s) may be in the closed conformation below a threshold temperature and in the opened conformation above a threshold temperature.

In some embodiments, the threshold temperature may be between about 20° C. to about 40° C., more specifically between about 25° C. and about 35° C. and in particular between about 28° C. to about 33° C.

In some embodiments, the one or more pore(s) may be in the closed conformation below a threshold pressure and in the opened conformation above a threshold pressure.

In some embodiments, the threshold pressure may be between about 1.2 bar to about 3 bar, more specifically between about 1.3 bar to about 2 bar and in particular between about 1.4 bar to about 1.7 bar.

In some embodiments, the one or more pore(s) may exhibit a diameter between about 10 μm to about 1000 μm, more specifically between about 50 μm to about 500 μm and in particular between about 100 μm to about 300 μm when in the closed conformation.

In some embodiments, the one or more pore(s) may exhibit a diameter between about 100 μm to about 5000 μm, more specifically between about 1000 μm to about 3000 μm and in particular between about 1500 μm to about 2500 μm when in the closed conformation.

In some embodiments, the lubricant's dynamic viscosity may be between about 5 cps to about 600 cps, more specifically between about 20 cps to about 400 cps and in particular between about 50 cps to about 200 cps at a shear rate of 5000 s⁻¹.

In some embodiments, the one or more pore(s)' diameter may increase between about 5% to about 50%, more specifically between about 10% to about 35% and in particular between about 15% to about 30% when the first polymeric material's temperature increases from 20° C. to a temperature of 50° C.

In some embodiments, the lubricant reservoir may comprise between about 1 to about 200, more specifically between about 5 to about 150 and in particular between about 30 to about 100 pores.

In some embodiments, the lubricant reservoir may comprise between about 200 to about 10000, more specifically between about 1000 to about 8000 and in particular between about 3000 to about 6000 pores.

In some embodiments, the lubricant reservoir may comprise a first polymeric material, wherein the first polymeric material comprises the one or more pore(s).

In some embodiments, the lubricant reservoir may comprise a shell, wherein the shell may comprise the first polymeric material.

In some embodiments, the first polymeric material may be elastic.

In some embodiments, the first polymeric material may have a Shore 00 hardness between about 0 to about 70, more specifically between about 10 to about 60 and in particular between about 20 to about 50, measured according to ASTM D2240-15(2021).

In some embodiments, the first polymeric material may have a Shore A hardness between about 0 to about 30, more specifically between about 5 to about 25 and in particular between about 10 to about 20, measured according to ASTM D2240-15(2021).

In some embodiments, the first polymeric material may comprise a first polymer.

In some embodiments, the first polymer may be a thermoresponsive polymer, in particular poly-N-isopropylacrylamide.

In some embodiments, the first polymeric material may comprise a second polymer, in particular polyacrylamide.

In some embodiments, the second polymer may be swellable, in particular in water.

In some embodiments, the first polymer may form a first polymer layer and the second polymer may form a second polymer layer.

In some embodiments, the first polymer and the second polymer may form separate layers or partly separate layers.

In some embodiments, the first polymer layer may form an inner layer of the lubricant reservoir (12), and the second polymer layer may form an outer layer of the lubricant reservoir.

In some embodiments, the first polymer layer may comprise a first section of the one or more pore(s) and the second polymer layer may comprise a second section of the one or more pore(s) 18, wherein the diameter of the first section of the one or more pore(s) increases when the temperature of the first polymer layer increases from 20° C. to 50° C. and/or wherein the diameter of the second section of the one or more pore(s) decreases when the temperature of the second polymer layer increases from 20° C. to 50° C.

In some embodiments, the first section's diameter may increase between about 5% to about 50%, more specifically between about 10% to about 35% and in particular between about 15% to about 30% when the first polymeric material's temperature increases from 20° C. to a temperature of 50° C.

In some embodiments, the second section's diameter may decrease between about 5% to about 50%, more specifically between about 10% to about 35% and in particular between about 15% to about 30% when the first polymeric material's temperature increases from 20° C. to a temperature of 50° C.

In some embodiments, the diameter of the one or more pore(s) at the lubricant reservoir's outer surface may increase between about 5% to about 50%, more specifically between about 10% to about 35% and in particular between about 15% to about 30% when the first polymeric material's temperature increases from 20° C. to a temperature of 50° C.

In some embodiments, the diameter of the one or more pore(s) at the lubricant reservoir's inner surface may decrease between about 5% to about 50%, more specifically between about 10% to about 35% and in particular between about 15% to about 30% when the first polymeric material's temperature increases from 20° C. to a temperature of 50° C.

In some embodiments, the first polymer layer and/or the second polymer layer may be microporous.

In some embodiments, the first polymeric material may comprise poly-N-isopropylacrylamide, polyacrylamide and/or copolymers thereof.

In some embodiments, the first polymeric material may comprise a layer of poly-N-isopropylacrylamide and a layer of polyacrylamide and in particular an outer layer of poly-N-isopropylacrylamide and an inner layer of polyacrylamide.

In some embodiments, the first polymeric material may comprise a silicone and/or a thermoplastic elastomer, in particular a thermoplastic vulcanizate and/or a styrenic block copolymer.

In some embodiments, the first polymer layer may have a thickness between about 0.05 mm to about 4 mm, more specifically between about 0.1 mm to about 1 mm and in particular between about 0.2 mm and about 0.5 mm.

In some embodiments, the second polymer layer may have a thickness between about 10 μm to about 1000 μm, more specifically between about 50 μm to about 500 μm and in particular between about 100 μm and about 300 μm.

In some embodiments, the lubricant reservoir may have a tubular shape.

In some embodiments, the lubricant reservoir may comprise a plurality of wall segments.

In some embodiments, a first wall segment of the plurality wall segments may have more pores than a second wall segment of the plurality of wall segments.

In some embodiments, the first wall segment of the plurality wall segments may have bigger pores than a second wall segment of the plurality of wall segments.

In some embodiments, the lubricant reservoir may be pivotable within the razor cartridge.

In some embodiments, the lubricant reservoir may be configured to be locked in place in different positions.

In some embodiments, the lubricant reservoir may be configured to be locked in place such that a single wall segment of the plurality of wall segments is exposed at a shaving side of the razor cartridge.

In some embodiments, the lubricant reservoir may comprise a stiff material and the first polymeric material.

In some embodiments, at least one wall segment of the plurality of wall segments may comprise the first polymeric material and at least one wall segment of the plurality of wall segments may comprise the stiff material.

In some embodiments, the lubricant reservoir may be a cuboid.

In some embodiments, five faces of the cuboid comprise the stiff material and one face may comprise the first polymeric material and wherein the first polymeric material may comprise the one or more pore(s).

In some embodiments, the lubricant reservoir may be a polyhedron, in particular a pentagonal prism or hexagonal prism.

In some embodiments, one face of the polyhedron may comprise the first polymeric material and wherein the first polymeric material may comprise the one or more pore(s).

In some embodiments, the lubricant reservoir may be pressurized above ambient pressure.

In some embodiments, the lubricant reservoir may comprise a pressurized gas, in particular pressurized air.

In some embodiments, the razor cartridge may comprise a detachable sealing membrane.

In some embodiments, the detachable sealing membrane may be configured to retain the lubricant at temperatures above the threshold temperatures.

In some embodiments, the detachable sealing membrane may be configured to retain the lubricant at pressures above the threshold pressure.

In some embodiments, the razor cartridge further may comprise a frame having a leading longitudinal side and a trailing longitudinal side. Furthermore, the razor cartridge may comprise one or more cutting members arranged between the leading longitudinal side and the trailing longitudinal side.

In some embodiments, the lubricant container may be arranged between the leading longitudinal side and the one or more cutting members.

In some embodiments, the lubricant container may be arranged between the trailing longitudinal side and the one or more cutting members.

In a second aspect, the present disclosure relates to a process for manufacturing a razor cartridge according to the disclosure, wherein the lubricant reservoir is press-fitted into a razor cartridge blank.

In a third aspect, the present disclosure relates to a process for manufacturing a razor cartridge according to the disclosure, wherein the lubricant reservoir is manufactured by manufacturing a razor cartridge blank comprising a recess and sealing the recess with the first polymeric material.

In a fourth aspect, the present disclosure relates to a shaving razor assembly comprising a razor handle; and a razor cartridge according to the disclosure, wherein the razor cartridge is either releasably attached to the razor handle via a pivotable or non-pivotable connection, integrally formed with the razor handle via a non-pivotable connection, or integrally formed with the razor handle via a pivotable connection.

### DETAILED DESCRIPTION

Hereinafter, a detailed description will be given of the present disclosure. The terms or words used in the description and the aspects of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

It has been surprisingly found that a razor cartridge (10) provided with a lubricant reservoir (12) having pores which can switch between a closed and an opened conformation based on an external stimulus can provide longer lasting lubrication to the user. Further, such a lubricant reservoir (12) may be mounted in the razor cartridge (10) at a late step during manufacturing, allowing a wider range of ingredients to be included in the lubricant reservoir (12).

Accordingly, in a first aspect, the present disclosure relates to a razor cartridge (10) comprising a lubricant reservoir (12) having one or more pore(s) (18), wherein the one or more pore(s) (18) are configured to switch between a closed conformation and an opened conformation based on an external stimulus.

The external stimulus may be temperature, stress, moisture, electric or magnetic fields, light, pH or chemical compounds, or a variation thereof.

The term “pore” within this disclosure is not particularly limited and i.a. refers to its common meaning in the art. Additionally or alternatively, the term “pore” may refer to voids within a material. The “pore” may pass through the entirety of a material or at least two pores may interconnect to pass through the entirety of a material. The “pore” may comprise an opening at a material's inner and outer surface and/or at the lubricant reservoir's (12) inner and outer surface. The material's inner and outer surface may be the same as the lubricant reservoir's (12) inner and outer surface. Alternatively, the material's outer surface may be disposed closer to the lubricant reservoir's (12) outer surface and/or the material's inner surface may be disposed closer to the lubricant reservoir's (12) inner surface.

Within this disclosure, the terms “opened” and “closed” conformation in regard to the pore(s) (18) should not be construed as referring to a state of complete closure of the pore and maximum dilation of a pore. The term “opened conformation” may refer to a conformation wherein the pore allows passing of a fluid from one end of the pore to another end of the pore. The term “closed conformation” may refer to a conformation wherein the pore blocks fluids from passing through the material. The void in a pore in a “closed conformation” may have collapsed and the void may be absent or substantially absent. The term “closed conformation” may also refer to a conformation wherein the pore's diameter at the inner or outer surface is smaller compared to the maximum dilation of the pore's diameter at the inner or outer surface. The inner or outer surface may be the material's inner or outer surface and/or the lubricant reservoir's (12) inner and outer surface.

A lubricant reservoir (12) having one or more pore(s) (18) configured to switch between a closed conformation and an opened conformation may provide a lubricant reservoir (12) with controllable lubricant (26) discharge. In some embodiments, the pore(s) (18) may be closed when the razor cartridge (10) is not in use, preventing the lubricant (26) from being discharged and/or contact to the environment. When the razor cartridge (10) is in use, the pore(s) (18) may open to discharge a lubricant (26) and/or skin active ingredients.

In some embodiments, the lubricant reservoir (12) may contain a lubricant (26). The lubricant (26) may be in the form of a gel, paste, or liquid. The lubricant (26) may provide lubrication between the skin and the razor cartridge, which in turn may reduce skin irritation caused by the shaving action. In particular, the lubricant (26) may comprise heat-sensitive compounds which are damaged, deteriorated and/or decomposed at higher temperatures, such as aloe vera gel. In some embodiments, higher temperatures may be considered to be temperatures above 50° C., more specifically above 75° C. and in particular above 100° C.

In some embodiments, lubricant reservoir (12) may comprise further ingredients, for example skin active agents. The further ingredients, in particular skin active agents, may be heat-sensitive compounds.

### Opening and Closing conditions

In some embodiments, the external stimulus may be a change in temperature and/or pressure.

Pore(s) (18) configured to switch their conformation based on a change in temperature may be in the closed conformation at ambient temperature, preventing discharge of the lubricant (26) and protecting the lubricant (26) from the environment when the razor cartridge (10) is not in use. In some embodiments, when the temperature of the pore(s) (18) or lubricant reservoir (12) is increased, due to contact with the user's skin and/or warm water, the pore(s) (18) may open to discharge the lubricant (26).

Pore(s) (18) configured to switch their conformation based on a change in pressure may be in the closed conformation at ambient pressure, preventing discharge of the lubricant (26) and protecting the lubricant (26) from the environment when the razor cartridge (10) is not in use. In some embodiments, when the pressure in the lubricant reservoir (12) is increased, for example due to being pressed against the user's skin, the pore(s) (18) may open to provide the lubricant (26). The pores may open due to the lubricant (26) exerting pressure upon the closed pores and squeezing into the void, leading to a dilation of the pore.

In some embodiments, the one or more pore(s) (18) may be in the closed conformation below a threshold temperature and in the opened conformation above a threshold temperature.

In some embodiments, the threshold temperature may be between about 20° C. to about 40° C., more specifically between about 25° C. and about 35° C. and in particular between about 28 C to about 33° C. A threshold temperature according to the ranges mentioned above may provide pore(s) (18) which are in the closed conformation at ambient temperatures and the opened conformation when in use, e.g. in contact with a user's skin.

In some embodiments, the one or more pore(s) (18) may be in the closed conformation below a threshold pressure and in the opened conformation above a threshold pressure.

In some embodiments, the threshold pressure may be between about 1.2 bar to about 3 bar, more specifically between about 1.3 bar to about 2 bar and in particular between about 1.4 bar to about 1.7 bar. A threshold pressure according to the ranges above may provide pore(s) (18) which are in the closed conformation at ambient pressures and the opened conformation when in use, e.g. when the lubricant reservoir (12) is pressed against a user's skin.

### Pore Size

The one or more pore(s) (18) do not necessarily need to have a diameter of about 0 when in the closed conformation. Due to the viscosity of fluids, the one or more pore(s) (18) may prevent the lubricant (26) form being discharged even when the diameter in the closed conformation is greater than 0.

In some embodiments, the one or more pore(s) (18) may exhibit a diameter between about 10 μm to about 1000 μm, more specifically between about 50 μm to about 500 μm and in particular between about 100 μm to about 300 μm when in the closed conformation. When lubricant reservoir (12) comprises multiple pores and the diameter of the multiple pores differs, the pore diameter may refer to the mean diameter of the multiple pores. The measurement of pore diameters is well known in the art. In some embodiments, the diameter of the one or more pore(s) (18) may be determined by capillary flow porometry, in particular the diameter of the one or more pore(s) may be determined as the mean pore size determined by capillary flow porometry. In some embodiments, the capillary flow porometry may be performed using for example a PMI Capillary Flow Porometer iPore 1500 by the company Porous Materials Inc, according to ASTM F316-03(2019).

Alternatively the pore diameter may also be determined by visual methods, e.g. by acquiring an image of the surface and measuring the width of the one or more pore(s) at the surface. The average width of the one or more pore(s) at the surface may be regarded as the diameter of the one or more pore(s). If the one or more pore(s)' exhibit multiple diameters, e.g. as the respective pore forms an ellipse or is non-circular at the surface, the hydraulic diameter may be regarded as the one or more pore(s)' (18) diameter. The image may be acquired by different methods depending on pore size. In some embodiments, the image may be acquired by photography, e.g. with a DSLR (for example a Canon EOS 80D) optionally with a telemetric lens, an SEM-microscope, or a 1D or 2D laser microscope. The images may be analyzed with any suitable program, for example ImageJ.

In some embodiments, the one or more pore(s) (18) may exhibit a diameter between about 100 μm to about 5000 μm, more specifically between about 1000 μm to about 3000 μm and in particular between about 1500 μm to about 2500 μm when in the closed conformation.

The one or more pore(s) (18) diameter may be chosen depending on the lubricant's (26) viscosity, in particular the diameter of the one or more pore(s) (18) may be increased with increasing dynamic viscosity of the lubricant (26). In some embodiments, the lubricant's (26) dynamic viscosity may be between about 5 cps to about 600 cps, more specifically between about 20 cps to about 400 cps and in particular between about 50 cps to about 200 cps at a shear rate of 5000 s⁻¹. The viscosity may be measured using a cone-plate rheometer, in particular a Kinexus Lab pro rheometer, by Netsch GmbH & Co. KG, Germany, at a temperature of 20° C., an angle between the cone and the surface of 1° and a cone diameter of 60 mm.

In some embodiments, the one or more pore(s)' (18) diameter may increase between about 5% to about 50%, more specifically between about 10% to about 35% and in particular between about 15% to about 30% when the first polymeric material's temperature increases from 20° C. to a temperature of 50° C.

A higher pore size may provide increased lubrication during the shaving action, however, it may also lead to the lubricant (26) being expended faster. Further, some lubricants (26) may have a high viscosity, thus, a higher pore size may improve the amount of discharged lubricant (26). Other lubricants (26) may exhibit a low viscosity, thus, a lower pore size may improve controlling discharge of the lubricant (26).

### Number of Pores

In some embodiments, the lubricant reservoir (12) may comprise between about 1 to about 200, more specifically between about 5 to about 150 and in particular between about 30 to about 100 pores.

In some embodiments, the lubricant reservoir (12) may comprise between about 200 to about 10000, more specifically between about 1000 to about 8000 and in particular between about 3000 to about 6000 pores.

A higher number of pores may provide increased lubrication during the shaving action, however, it may also lead to the lubricant (26) being expended faster. Further, a higher number of pores may be combined with a smaller pore size and vice versa, for improved discharge of the lubricant (26).

### Material

In some embodiments, the lubricant reservoir (12) may comprise a first polymeric material, and wherein the first polymeric material comprises the one or more pore(s).

In some embodiments, the lubricant reservoir (12) may comprise a shell, wherein the shell may comprise the first polymeric material.

In some embodiments, the first polymeric material may be elastic. An elastic first polymeric material, in particular an elastic first polymeric material comprised in the shell, may transfer pressure from being pressed against the user's skin to the lubricant (26).

In some embodiments, the first polymeric material may have a Shore 00 hardness between about 0 to about 70, more specifically between about 10 to about 60 and in particular between about 20 to about 50, measured according to ASTM D2240-15(2021).

In some embodiments, the first polymeric material may have a Shore A hardness between about 0 to about 30, more specifically between about 5 to about 25 and in particular between about 10 to about 20, measured according to ASTM D2240-15(2021).

A softer first polymeric material may transfer pressure to the lubricant (26) more efficiently, but may also deform strongly. A stiffer first polymeric material may deform less upon pressure, e.g. when pressed against the user's skin, which may allow the lubricant reservoir (12) to slide along the user's skin with less force.

In some embodiments, the first polymeric material may comprise a first polymer. In some embodiments, the first polymer may comprise a thermoresponsive polymer, in particular poly-N-isopropylacrylamide. At temperatures below the threshold temperature a thermoresponsive polymer may be in an elongated state and at temperatures above the threshold temperature the thermoresponsive polymer may be in a collapsed state. Without wishing to be bound by theory, the elongation of the thermoresponsive polymer may lead to an increase of its volume leading to closure of the pores below the threshold temperature and to a decrease in volume above the threshold temperature of the thermoresponsive polymer leading to opening of the pores. In some embodiments, the thermoresponsive polymer may form tubular structures, wherein the pore forms the void within the tubular structure. In particular, a thermoresponsive polymer may be more hydrophilic below the threshold temperature compared to above the threshold temperature, which may lead to swelling of the polymer by water, in turn increasing the thermoresponsive polymer's volume. When the temperature of the thermoresponsive polymer reaches a temperature above the threshold temperature, the hydrophobicity of the thermoresponsive polymer, which may lead to the excretion of water from the polymer, leading to a reduction in the thermoresponsive polymer's volume, thus a shrinking of the thermoresponsive polymer.

In some embodiments, the first polymeric material may comprise a second polymer, in particular polyacrylamide. In some embodiments, the second polymer may be swellable, in particular in water. A second polymer swellable, in particular in water may be manufactured comprising one or more pore(s) (18) in an opened conformation. Without wishing to be bound by theory, the one or more pore(s) (18) may be in the closed conformation when the polymer is swollen with water, as the volume of the polymer increases. The lubricant (26) may then be pressed through the one or more pore(s) (18) in the closed conformation when the pressure in the lubricant reservoir (12) is increased, which leads to opening of the pore(s) (18) and discharge of the lubricant (26). Alternatively or additionally, in some embodiments, the second polymer may have a positive coefficient of thermal expansion. As a result, when the temperature increases, the second polymer may increase in volume, which in turn may result in closing or volume reduction of the one or more pore(s) (18).

In some embodiments, the first polymer may form a first polymer layer and the second polymer may form a second polymer layer. In some embodiments, the first polymer layer and the second polymer layer may be interconnected. In some embodiments, the first and second polymer layer may be manufactured by additive manufacturing, e.g. by 3D-printing and the second polymer layer was printed on the first polymer layer. In some embodiments, the first and second polymer layer may comprise the one or more pore(s) (18), in particular wherein the first and second polymer layer's one or more pore(s) (18) are interconnected. Again, without wishing to be bound by theory, the first polymer and thereby the first polymer layer may contract when above the threshold temperature, thereby expanding the diameter of the one or more pore(s) (18) comprised within the material. However, the second polymer and thereby the second polymer layer may expand due to an increase in temperature, thereby reducing the diameter of the one or more pore(s) (18). The one or more pore(s) (18) expanding in the first polymer layer and contracting in the second polymer layer may allow fine tuning the discharge of lubricant (26).

Further, in some embodiments, the second polymer layer may be arranged closer to the lubricant (26) than the first polymer layer. In some embodiments, the second polymer layer may form an inner layer of the lubricant reservoir (12) and the first polymer layer may form an outer layer of the lubricant reservoir (12). Again, without wishing to be bound by theory, at a lower temperature the pore(s) (18) in the first polymer layer, in particular the first polymer layer forming the outer layer, may be closed preventing the discharge of lubricant (26) from the lubricant reservoir (12), while the lubricant (26) can enter the one or more pore(s) (18) in the second polymer layer, in particular the second polymer layer forming the inner layer. When the temperature increases the diameter of the one or more pore(s) (18) in the second polymer layer decreases and the one or more pore(s) (18) may close on the side facing towards the lubricant (12). However, the second polymer layer's one or more pores' (18) side facing towards the first polymer layer may be held open by the dilating one or more pore(s) (18) of the shrinking first polymer layer whereto the second polymer layer is interconnected. This may create a pump action by the second polymer layer due to the one or more pore(s) (18) in the second polymer layer decreasing in overall volume but only being opened on the side facing towards the first polymer layer.

In some embodiments, the first polymer layer may comprise a first section of the one or more pore(s) (18) and the second polymer layer may comprise a second section of the one or more pore(s) 18, wherein the diameter of the first section of the one or more pore(s) (18) increases when the temperature of the first polymer layer increases from 20° C. to 50° C. and/or wherein the diameter of the second section of the one or more pore(s) decreases when the temperature of the second polymer layer increases from 20° C. to 50° C.

In some embodiments, the first section's diameter may increase between about 5% to about 50%, more specifically between about 10% to about 35% and in particular between about 15% to about 30% when the first polymeric material's temperature increases from 20° C. to a temperature of 50° C.

In some embodiments, the second section's diameter may decrease between about 5% to about 50%, more specifically between about 10% to about 35% and in particular between about 15% to about 30% when the first polymeric material's temperature increases from 20° C. to a temperature of 50° C.

In some embodiments, the diameter of the one or more pore(s) (18) at a lubricant reservoir's (12) outer surface increases when the temperature of the first polymer layer increases from 20° C. to 50° C. and/or the diameter of the one or more pore(s) at a lubricant reservoir's (12) inner surface decreases when the temperature of the second polymer layer increases from 20° C. to 50° C. The term “inner surface” may refer to the surface oriented towards the lubricant (12) and the term “outer surface” may refer to the surface oriented away from the lubricant (12) and/or towards the user in use. As the first and second polymer layer may be interconnected, the pore diameter of the first and second section at the interface of the first and section may be equal. However, the diameter of the one or more pore(s) (18) at the outer and inner surface of the lubricant reservoir may differ.

In some embodiments, the diameter of the one or more pore(s) (18) at the lubricant reservoir's (12) outer surface may increase between about 5% to about 50%, more specifically between about 10% to about 35% and in particular between about 15% to about 30% when the first polymeric material's temperature increases from 20° C. to a temperature of 50° C.

In some embodiments, the diameter of the one or more pore(s) (18) at the lubricant reservoir's (12) inner surface may decrease between about 5% to about 50%, more specifically between about 10% to about 35% and in particular between about 15% to about 30% when the first polymeric material's temperature increases from 20° C. to a temperature of 50° C.

In some embodiments, the first and/or the second polymer may comprise a silicone rubber, a thermoplastic elastomer vulcanizate and/or a styrene based thermoplastic elastomer.

In some embodiments, the first polymer layer and the second polymer layer may form separate layers or partly separate layers. The first and second polymer layers being separate or partly separate may allow the polymer layers to expand and shrink independently. In some embodiments, the one or more pore(s) of the first and second polymer layer may not be aligned and/or interconnected at lower temperatures, thus there is no passage from the lubricant reservoir's (12) inside to the outside. However, when the temperature increases, for example to the threshold temperature, the shrinking of the first polymer layer and the expansion of the second polymer layer may result in the one or more pore(s) aligning and/or interconnecting, leading to the formation of a passage from the lubricant reservoir's (12) inside to the outside.

In some embodiments, the first polymer and/or the second polymer may be microporous. The term microporous within this disclosure is not particularly limited and may i.a. refer to its common meaning in the art. Additionally or alternatively, may refer to the material comprising pores in a size between 1 μm to 5000 μm.

In some embodiments, the first polymeric material may comprise poly-N-isopropylacrylamide, polyacrylamide and/or copolymers thereof. Poly-N-isopropylacrylamide may be a temperature responsive polymer.

In some embodiments, the first polymeric material may comprise a layer of poly-N-isopropylacrylamide and a layer of polyacrylamide and in particular an outer layer of poly-N-isopropylacrylamide and an inner layer of polyacrylamide.

In some embodiments, the first polymeric material may comprise a silicone and/or a thermoplastic elastomer, in particular a thermoplastic vulcanizate and/or a styrenic block copolymer. In some embodiments, the first polymeric material may not comprise a thermoresponsive polymer. Instead, the first polymeric material may comprise a silicone and/or a thermoplastic elastomer. The opening and closing of the pores may then depend upon the pressure within the lubricant reservoir (12), such that an increased pressure results in lubricant (26) squeezing through the one or more pore(s) (18). Further, a first polymeric material comprising a silicone and/or a thermoplastic elastomer may stretch during the shaving action due to friction with the user's skin, which may result in opening of the one or more pore(s) (18). The one or more pore(s) (18) opening due to increased friction with a user's skin may be advantageous as the flow of lubricant (26) may be increased, when the friction is increased, leading to an automatically adjusted lubricant (26) flow.

### Thickness

In some embodiments, the second polymer layer may have a thickness between about 10 μm to about 1000 μm, more specifically between about 50 μm to about 500 μm and in particular between about 100 μm and about 300 μm.

In some embodiments, the first polymer layer may have a thickness between about 0.05 mm to about 4 mm, more specifically between about 0.1 mm to about 1 mm and in particular between about 0.2 mm and about 0.5 mm.

Thicker layers of the first and/or second polymer may increase the durability of the container, however this may also impede the discharge of the lubricant (26).

### Rotation

In some embodiments, the lubricant reservoir (12) may have a tubular shape.

In some embodiments, lubricant reservoir (12) may comprise a plurality of wall segments.

In some embodiments, a first wall segments of the plurality wall segments may have more pores than a second wall segment of the plurality of wall segments.

In some embodiments, the first wall segments of the plurality wall segments may have bigger pores than a second wall segment of the plurality of wall segments.

In some embodiments, the lubricant reservoir (12) may be pivotable within the razor cartridge (10).

A pivotable lubricant reservoir (12) having a plurality of wall segments, wherein the wall segments have different amounts of pores and/or pores of different sizes, may allow a user to control the amount of lubrication provided during the shaving action.

In some embodiments, the lubricant reservoir (12) may be configured to be locked in place in different positions. Locking the lubricant reservoir (12) in place may be necessary to prevent the lubricant reservoir (12) from pivoting during the shaving action.

In some embodiments, the lubricant reservoir (12) may be configured to be locked in place such that a single wall segment of the plurality of wall segments is exposed at a shaving side of the razor cartridge (10).

### Fixed Volume Lubricant Reservoir

In some embodiments, the lubricant reservoir (12) may comprise a stiff material and the first polymeric material. The stiff material may comprise a second polymeric material, in particular a second polymeric material with a higher Shore hardness compared to the first polymeric material. The stiff material may comprise acrylonitrile-butadiene-styrene copolymer (ABS), polypropylene, polyethylene terephthalate glycol-modified polymer (PETG) and/or mixtures thereof. The stiff material may have a shore D hardness between about 40 to 105, more specifically between about 50 to about 110, and in particular between about 55 to about 100, measured according to ASTM D2240-15(2021)

In some embodiments, at least one wall segment of the plurality of wall segments may comprise the first polymeric material and at least one wall segment of the plurality of wall segments may comprise the stiff material.

In some embodiments, the lubricant reservoir (12) may be a cuboid.

In some embodiments, five faces (20 a, b, c, d, e) of the cuboid may comprise the stiff material and one face (22) may comprise the first polymeric material and wherein the first polymeric material may comprise the one or more pore(s) (18).

In some embodiments, the lubricant reservoir (12) may be a polyhedron, in particular a pentagonal prism or hexagonal prism.

In some embodiments, one face (22) of the polyhedron may comprise the first polymeric material and wherein the first polymeric material may comprise the one or more pore(s) (18).

A cuboid or polyhedron as specified above may allow easy manufacture of the lubricant reservoir (12), while still providing one side with one or more pore(s) (18) configured to switch between the closed conformation and the opened conformation.

In some embodiments, the lubricant reservoir (12) may be pressurized above ambient pressure.

In some embodiments, the lubricant reservoir (12) may comprise a pressurized gas, in particular pressurized air. A pressurized lubricant reservoir (12), in particular one pressurized by gas, may provide longer lasting lubrication, as the pressure in the lubricant reservoir (12) may stay at an increased level, thereby still reaching the threshold pressure when pressed against a user's skin when a substantial amount of lubricant (26) has already been discharged.

### Sealing Membrane

In some embodiments, the razor cartridge (10) may comprise a detachable sealing membrane.

In some embodiments, the detachable sealing membrane may be configured to retain the lubricant (26) at temperatures above the threshold temperatures.

In some embodiments, the detachable sealing membrane may be configured to retain the lubricant (26) at pressures above the threshold pressure.

The detachable sealing membrane may protect the lubricant reservoir (12) from discharging lubricant (26) before its use, when the ambient pressure or temperature is increased, e.g. during storage or transport. In some embodiments, the sealing membrane may be a plastic film, for example a PVC or cellophane film. In some embodiments, the detachable sealing membrane may be a panel, in particular a plastic panel.

In some embodiments, the razor cartridge (10) further may comprise a frame having a leading longitudinal side (14) and a trailing longitudinal side (16). Further the razor cartridge may comprise one or more cutting member(s) (24) arranged between the leading longitudinal side (14) and the trailing longitudinal side (16).

In some embodiments, the lubricant reservoir (12) may be arranged between the leading longitudinal side (14) and the one or more cutting member(s) (24). In this configuration, the lubricant reservoir (12) may provide lubrication to the skin before the skin comes into contact with the one or more cutting member(s) (24).

In some embodiments, the lubricant reservoir (12) may be arranged between the trailing longitudinal side (16) and the one or more cutting member(s) (24). Providing the lubricant reservoir (12) between the trailing longitudinal side (16) and the one or more cutting member(s) (24) may be advantageous to improve the provision of skin care agents to the skin after they have come into contact with the cutting members.

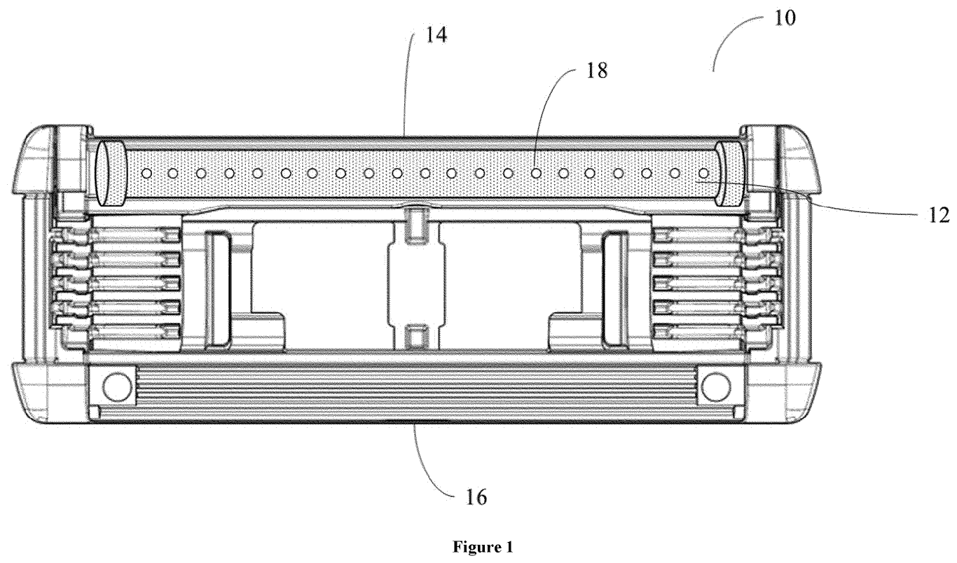

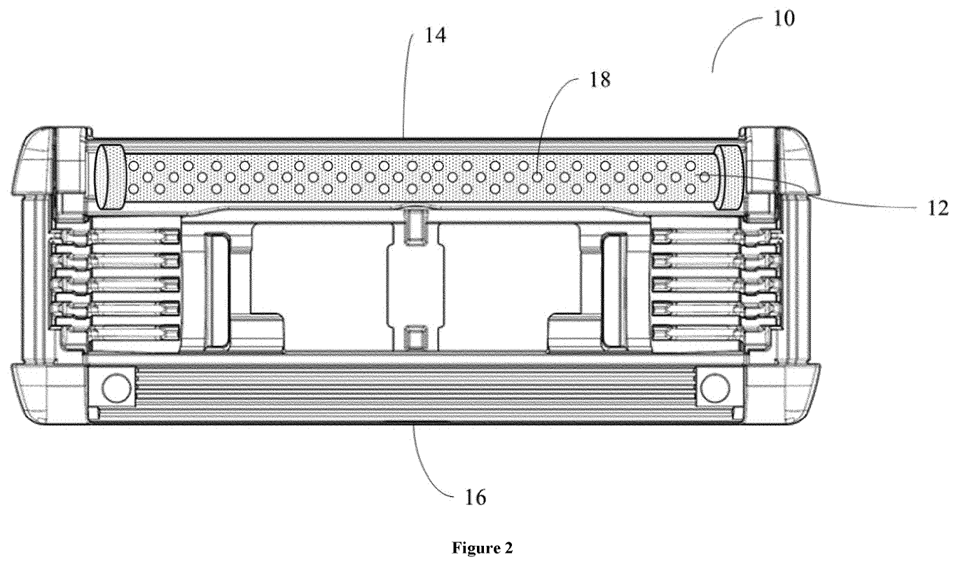

FIG. 1 shows a razor cartridge (10) comprising a pivotable lubricant reservoir (12) arranged between the leading longitudinal side (14) and the trailing longitudinal side (16). The lubricant reservoir (12) exposes a first wall segment comprising a plurality of pores (18). FIG. 2 shows the razor cartridge (10) with a pivoted lubricant reservoir (12) exposing a second wall segment with a higher number of pores (18) compared to the first wall segment.

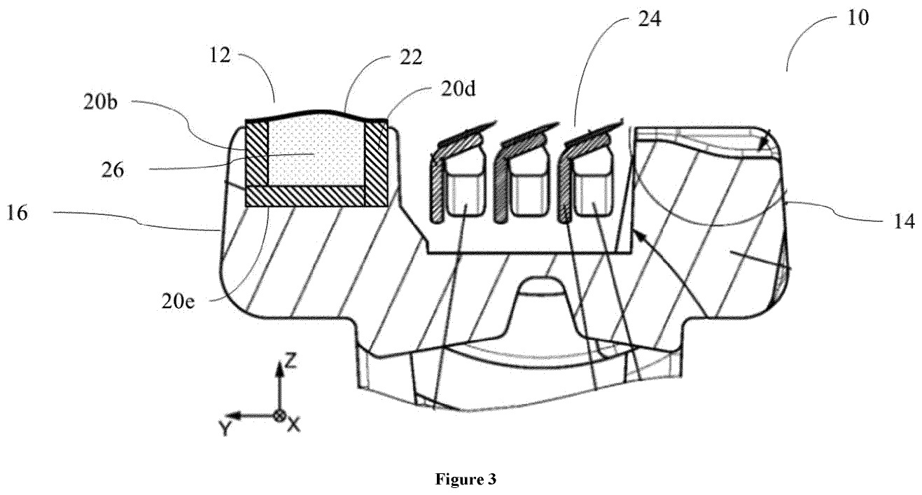

FIG. 3 shows a razor cartridge 10 comprising a plurality of cutting members (24) and a lubricant reservoir (12) arranged between a leading longitudinal side (14) and a trailing longitudinal side (16). The lubricant reservoir comprises faces (20 b, d, e) made of stiff material, lubricant (26) and one face (22) comprising the first polymeric material.

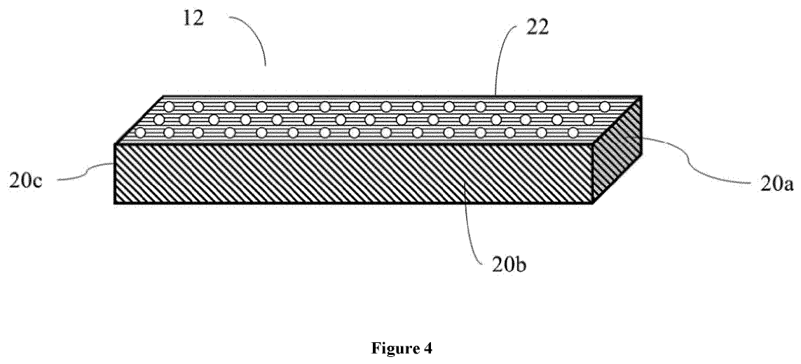

FIG. 4 shows a lubricant reservoir (12) comprising faces (20 a, b, c) comprising the stiff material and one face (22) comprising the first polymeric material, as well as pores (18).

In a second aspect, the present disclosure relates to a process for manufacturing the razor cartridge (10) according to any preceding claim, wherein the lubricant reservoir (12) is press-fitted into a razor cartridge (10) blank. Press-fitting the lubricant reservoir (12) may be advantageous as it may be performed as a late step during manufacturing, thereby preventing the lubricant reservoir (12) being exposed to elevated temperatures which may be necessary for other manufacturing steps.

In a third aspect, the present disclosure relates to a process for manufacturing the razor cartridge (10) disclosed above, wherein the lubricant reservoir (12) is manufactured by manufacturing a razor cartridge (10) blank comprising a recess and sealing the recess with the first polymeric material.

In a fourth aspect, the present disclosure relates to a shaving razor assembly comprising:
a razor handle; and
a razor cartridge (10) as disclosed above, wherein the razor cartridge (10) is either releasably attached to the razor handle via a pivotable or non-pivotable connection, integrally formed with the razor handle via a non-pivotable connection, or integrally formed with the razor handle via a pivotable connection.

### Aspects

The present disclosure furthermore relates to the following aspects.
1. A razor cartridge comprising a lubricant reservoir having one or more pore(s), wherein the one or more pore(s) are configured to switch between a closed conformation and an opened conformation based on an external stimulus.
2. The razor cartridge according to aspect 1, wherein the lubricant reservoir contains a lubricant.
3. The razor cartridge according to any preceding aspect, wherein the external stimulus is a change in temperature and/or pressure.
4. The razor cartridge according to any preceding aspect, wherein the one or more pore(s) are in closed conformation below a threshold temperature and in an opened conformation above a threshold temperature.
5. The razor cartridge according to aspect 4, wherein the threshold temperature is between about 20° C. to about 40° C., more specifically between about 25° C. and about 35° C. and in particular between about 28° C. to about 33° C.
6. The razor cartridge according to any preceding aspect, wherein the one or more pore(s) are in closed conformation below a threshold pressure and in an opened conformation above a threshold pressure.
7. The razor cartridge according to aspect 6, wherein the threshold pressure is between about 1.2 bar to about 3 bar, more specifically between about 1.3 bar to about 2 bar and in particular between about 1.4 bar to about 1.7 bar.
8. The razor cartridge according to any preceding aspect, wherein the one or more pore(s) exhibit a diameter between about 10 μm to about 1000 μm, more specifically between about 50 μm to about 500 μm and in particular between about 100 μm to about 300 μm when in the closed conformation.
9. The razor cartridge according to any one of aspects 1 to 8, wherein the one or more pore(s) exhibit a diameter between about 100 μm to about 5000 μm, more specifically between about 1000 μm to about 3000 μm and in particular between about 1500 μm to about 2500 μm when in the closed conformation.
10. The razor cartridge according to any one of aspects 1 to 9, wherein the lubricant's dynamic viscosity is between about 5 cps to about 600 cps, more specifically between about 20 cps to about 400 cps and in particular between about 50 cps to about 200 cps at a shear rate of 5000 s⁻¹.
11. The razor cartridge according to any preceding aspect, wherein the one or more pore(s)' diameter increases between about 5% to about 50%, more specifically between about 10% to about 35% and in particular between about 15% to about 30% when the first polymeric material's temperature increases from 20° C. to a temperature of 50° C.
12. The razor cartridge according to any preceding aspect, wherein the lubricant reservoir comprises between about 1 to about 200, more specifically between about 5 to about 150 and in particular between about 30 to about 100 pores.
13. The razor cartridge according to any one of aspects 1 to 11, wherein the lubricant reservoir comprises between about 200 to about 10000, more specifically between about 1000 to about 8000 and in particular between about 3000 to about 6000 pores.
14. The razor cartridge according to any preceding aspect, wherein the lubricant reservoir (12) comprises a first polymeric material, and wherein the first polymeric material comprises the one or more pore(s).
15. The razor cartridge according to aspect 14, wherein the lubricant reservoir comprises a shell, wherein the shell comprises the first polymeric material.
16. The razor cartridge according to aspect 14 or 15, wherein the first polymeric material is elastic.
17. The razor cartridge according to aspect 14 or 16, wherein the first polymeric material has a Shore 00 hardness between about 0 to about 70, more specifically between about 10 to about 60 and in particular between about 20 to about 50, measured according to ASTM D2240-15(2021).
18. The razor cartridge according to any one of aspects 14 to 16, wherein the first polymeric material has a Shore A hardness between about 0 to about 30, more specifically between about 5 to about 25 and in particular between about 10 to about 20, measured according to ASTM D2240-15(2021).
19. The razor cartridge according to any one of aspects 14 to 17, wherein the first polymeric material comprises a first polymer.
20. The razor cartridge according to aspect 19, wherein the first polymer is a thermoresponsive polymer, in particular poly-N-isopropylacrylamide.
21. The razor cartridge according to any one of aspects 14 to 20, wherein the first polymeric material comprises a second polymer, in particular polyacrylamide.
22. The razor cartridge according to aspect 21, wherein the second polymer is swellable, in particular in water.
23. The razor cartridge according to any one of aspects 21 to 22, the first polymer forms a first polymer layer and the second polymer may form a second polymer layer.
24. The razor cartridge according to aspect 23, wherein the first polymer layer forms an outer layer of the lubricant reservoir (12), and the second polymer layer forms an inner layer of the lubricant reservoir (12).
25. The razor cartridge according to aspect 23 or 24, wherein the first polymer layer comprises a first section of the one or more pore(s) (18) and the second polymer layer may comprise a second section of the one or more pore(s) (18), wherein the diameter of the first section of the one or more pore(s) (18) increases when the temperature of the first polymer layer increases from 20° C. to 50° C. and/or wherein the diameter of the second section of the one or more pore(s) decreases when the temperature of the second polymer layer increases from 20° C. to 50° C.
26. The razor cartridge according to aspect 25, wherein the first section's diameter increases between about 5% to about 50%, more specifically between about 10% to about 35% and in particular between about 15% to about 30% when the first polymeric material's temperature increases from 20° C. to a temperature of 50° C.
27. The razor cartridge according to aspect 25 or 26, wherein the second section's diameter decreases between about 5% to about 50%, more specifically between about 10% to about 35% and in particular between about 15% to about 30% when the first polymeric material's temperature increases from 20° C. to a temperature of 50° C.
28. The razor cartridge according to any preceding aspect, wherein the diameter of the one or more pore(s) (18) at the lubricant reservoir's (12) outer surface increases between about 5% to about 50%, more specifically between about 10% to about 35% and in particular between about 15% to about 30% when the first polymeric material's temperature increases from 20° C. to a temperature of 50° C.
29. The razor cartridge according to any preceding aspect, wherein the diameter of the one or more pore(s) (18) at the lubricant reservoir's (12) inner surface decreases between about 5% to about 50%, more specifically between about 10% to about 35% and in particular between about 15% to about 30% when the first polymeric material's temperature increases from 20° C. to a temperature of 50° C.
30. The razor cartridge according to any one of aspects 21 to 29, wherein the first polymer and/or the second polymer are microporous.
31. The razor cartridge according to any one of aspects 14 to 30, wherein the first polymeric material comprises poly-N-isopropylacrylamide, polyacrylamide and/or copolymers thereof.
32. The razor cartridge according to any one of aspects 14 to 31, wherein the first polymeric material comprises a layer of poly-N-isopropylacrylamide and a layer of polyacrylamide and in particular an outer layer of poly-N-isopropylacrylamide and an inner layer of polyacrylamide.
33. The razor cartridge according to any one of aspects 14 to 32, wherein the first polymeric material comprises a silicone and/or a thermoplastic elastomer, in particular a thermoplastic vulcanizate and/or a styrenic block copolymer.
34. The razor cartridge according to any one of aspects 23 to 33, wherein the first polymer layer has a thickness between about 0.05 mm to about 4 mm, more specifically between about 0.1 mm to about 1 mm and in particular between about 0.2 mm and about 0.5 mm.
35. The razor cartridge according to any one of aspects 23 to 33, wherein the second polymer layer has a thickness between about 10 μm to about 1000 μm, more specifically between about 50 μm to about 500 μm and in particular between about 100 μm and about 300 μm.
36. The razor cartridge according to any preceding aspect, wherein the lubricant reservoir has a tubular shape.
37. The razor cartridge according to any preceding aspect, wherein lubricant reservoir comprises a plurality of wall segments.
38. The razor cartridge according to aspect 37, wherein a first wall segments of the plurality wall segments has more pores than a second wall segment of the plurality of wall segments.
39. The razor cartridge according to aspect 37 or 38, wherein a first wall segments of the plurality wall segments has bigger pores than a second wall segment of the plurality of wall segments.
40. The razor cartridge according to any preceding aspect, wherein the lubricant reservoir is pivotable within the razor cartridge.
41. The razor cartridge according to aspect 40, wherein the lubricant reservoir is configured to be locked in place in different positions.
42. The razor cartridge according to aspect 41, wherein the lubricant reservoir is configured to be locked in place such that a single wall segment of the plurality of wall segments is exposed at a shaving side of the razor cartridge.
43. The razor cartridge according to any preceding aspect, wherein the lubricant reservoir comprises a stiff material and a first polymeric material.
44. The razor cartridge according to any one of aspects 37 to 43, wherein at least one wall segment of the plurality of wall segments comprises the first polymeric material and at least one wall segment of the plurality of wall segments comprises the stiff material.
45. The razor cartridge according to any preceding aspect, wherein the lubricant reservoir is a cuboid.
46. The razor cartridge according to aspect 45, wherein five faces of the cuboid comprise the stiff material and one face comprises the first polymeric material and wherein the first polymeric material comprises the one or more pore(s).
47. The razor cartridge according to any preceding aspect, wherein the lubricant reservoir is a polyhedron, in particular a pentagonal prism or hexagonal prism.
48. The razor cartridge according to aspect 47, wherein one face of the polyhedron comprises the first polymeric material and wherein the first polymeric material comprises the one or more pore(s).
49. The razor cartridge according to any preceding aspect, wherein the lubricant reservoir is pressurized above ambient pressure.
50. The razor cartridge according to any preceding aspect, wherein the lubricant reservoir comprises a pressurized gas, in particular pressurized air.
51. The razor cartridge according to any preceding aspect, wherein the razor cartridge comprises a detachable sealing membrane.
52. The razor cartridge according to aspect 51, wherein the detachable sealing membrane is configured to retain the lubricant at temperatures above the threshold temperatures.
53. The razor cartridge according to aspect 51 or 52, wherein the detachable sealing membrane is configured to retain the lubricant at pressures above the threshold pressure.
54. The razor cartridge according to any preceding aspect, wherein the razor cartridge further comprises a frame having a leading longitudinal side and a trailing longitudinal side;
   one or more cutting members arranged between the leading longitudinal side and the trailing longitudinal side.
55. The razor cartridge according to aspect 54, wherein the lubricant container is arranged between the leading longitudinal side and the one or more cutting members.
56. The razor cartridge according to aspect 54, wherein the lubricant container is arranged between the trailing longitudinal side and the one or more cutting members.
57. A process for manufacturing the razor cartridge according to any preceding aspect, wherein the lubricant reservoir is press-fitted into a razor cartridge blank.
58. A process for manufacturing the razor cartridge according to any one of aspects 43 to 57, wherein the lubricant reservoir is manufactured by manufacturing a razor cartridge blank comprising a recess and sealing the recess with the first polymeric material.
59. A shaving razor assembly comprising:
   a razor handle; and
   a razor cartridge according to any preceding aspect, wherein the razor cartridge is either releasably attached to the razor handle via a pivotable or non-pivotable connection, integrally formed with the razor handle via a non-pivotable connection, or integrally formed with the razor handle via a pivotable connection.

1. A razor cartridge comprising a lubricant reservoir having one or more pore(s),
wherein the one or more pore(s) are configured to switch between a closed conformation and an opened conformation based on an external stimulus.

2. The razor cartridge according to claim 1, wherein the external stimulus is a change in temperature and/or pressure.

3. The razor cartridge according to claim 1, wherein the one or more pore(s) are in the closed conformation below a threshold temperature and in the opened conformation above a threshold temperature.

4-15. (canceled).

16. The razor cartridge according to claim 3, wherein the threshold temperature is between about 20° C. to about 40° C.

17. The razor cartridge according to claim 1, wherein the one or more pore(s) are in the closed conformation below a threshold pressure and in the opened conformation above a threshold pressure.

18. The razor cartridge according to claim 1, wherein the lubricant reservoir comprises a first polymeric material, wherein the first polymeric material comprises the one or more pore(s).

19. The razor cartridge according to claim 18, wherein the first polymeric material comprises poly-N-isopropylacrylamide, polyacrylamide and/or copolymers thereof.

20. The razor cartridge according to claim 18, wherein the lubricant reservoir comprises a shell, wherein the shell comprises the first polymeric material.

21. The razor cartridge according to claim 18, wherein the first polymeric material is elastic.

22. The razor cartridge according to claim 18, wherein the first polymeric material has a Shore 00 hardness between about 0 to about 70, measured according to ASTM D2240-15(2021).

23. The razor cartridge according to claim 18, wherein the first polymeric material comprises a first polymer and/or wherein the first polymeric material comprises a second polymer.

24. The razor cartridge according to claim 23, wherein the first polymer is a thermoresponsive polymer.

25. The razor cartridge according to claim 23, wherein the first polymer is poly-N-isopropylacrylamide.

26. The razor cartridge according to claim 23, wherein the second polymer is polyacrylamide.

27. The razor cartridge according to claim 23, wherein the first polymer forms a first polymer layer and the second polymer forms a second polymer layer.

28. The razor cartridge according to claim 1, wherein a diameter of the one or more pore(s) at a lubricant reservoir's outer surface increases between about 5% to about 50% when the first polymeric material's temperature increases from 20° C. to a temperature of 50° C. and/or wherein the diameter of the one or more pore(s) at a lubricant reservoir's inner surface decreases between about 5% to about 50% when the first polymeric material's temperature increases from 20° C. to a temperature of 50° C.

29. The razor cartridge according to claim 1, wherein lubricant reservoir comprises a plurality of wall segments, wherein at least one first wall segment of the plurality of wall segments comprises a first polymeric material and wherein at least one second wall segment of the plurality of wall segments comprises a stiff material.

30. The razor cartridge according to claim 29, wherein the stiff material comprises acrylonitrile-butadiene-styrene copolymer (ABS), polypropylene, polyethylene terephthalate glycol-modified polymer (PETG) and/or mixtures thereof.

31. A process for manufacturing the razor cartridge according to claim 1, wherein the lubricant reservoir is press-fitted into a razor cartridge blank or wherein the lubricant reservoir is manufactured by manufacturing a razor cartridge blank comprising a recess and sealing the recess with the first polymeric material.

32. A shaving razor assembly comprising:
a razor handle; and
a razor cartridge according to claim 1, wherein the razor cartridge is either releasably attached to the razor handle via a pivotable or non-pivotable connection, integrally formed with the razor handle via a non-pivotable connection, or integrally formed with the razor handle via a pivotable connection.
